(19) United States
(12) Patent Application Publication
(10) Pub. No.: US 2010/0231395 A1
(43) Pub. Date: Sep. 16, 2010

(54) Multifunctional Power Bank Structure

(76) Inventors: Shih-Hui Chen, Luchu Hsiang (TW); Chin-Tien Lin, Luchu Hsiang (TW)

Correspondence Address: Jackson Intellectual Property Group PLLC, 106 Starvale Lane, Shipman, VA, 22971, US

(21) Appl. No.: 12/173,861

(22) Filed: Jul. 16, 2008

(30) Foreign Application Priority Data
Jul. 6, 2007 (TW) 096211000

(51) Int. Cl. G08B 21/18; G08B 3/10; G08B 5/22

(52) U.S. Cl. 340/636.2; 340/692; 340/691.6

(57) ABSTRACT

A multifunctional power bank includes a box for installing different component modules, an electric power unit and a sound producing unit, both installed in the box, and an interface disposed on the box and connected to an external electronic device, wherein the sound producing unit is connected to the electric power unit, and the interface is connected to the electric power unit. When the power bank is connected to the electronic device through the interface, the electric power unit can exchange electric power with the electronic device, and the sound producing unit can issue a warning to users.

### BACKGROUND OF THE INVENTION

(a) Field of the Invention

The present invention relates to a multifunctional power bank structure, and more particularly to a power bank structure having a built-in sound producing unit for issuing a warning.

(b) Description of the Prior Art

As digital electronic products have become an indispensable part of our life, we often use digital electronic products such as digital cameras, digital photography equipments, and even MP4 digital audio/video players regardless of our requirements at home, in office, or on a tour or a business trip. For instance, users usually use digital cameras and MP4 players for fun and personal digital assistants or notebook computers for business, and thus the digital electronic products bring tremendous convenience to users.

As to those portable digital electronic products with no utility power supply, the power supply time of the battery become a big issue, and the battery manufactured by original manufacturers is too expensive and the power supply time is too short, and some of the batteries cannot be recharged during the use of the digital electronic product. Obviously, such digital electronic products cannot maximize their utility, and thus power bank is introduced to overcome this issue.

With reference to FIG. 1 for a structure of a general power bank 1, the power bank 1 includes a plurality of built-in chargeable batteries 11 and a transmission line 12 for connecting the power bank 1 with an electronic device 2 to supply electric power to the electronic device 2. In addition to the power storage and transmission functions of the power bank, manufacturers also attempt to bundle value-added functions into the power bank.

### SUMMARY OF THE INVENTION

Therefore, it is a primary objective of the present invention to provide a multifunctional power bank structure having a built-in sound producing unit for giving a warning.

To achieve the foregoing objective, the multifunctional power bank structure of the invention comprises a box for installing various different component modules, an electric power unit and a sound producing unit installed in the box, and an interface disposed on the box and connected to an external electronic device, wherein the sound producing unit is connected to the electric power unit, and the interface is connected to the electric power unit. When the power bank is connected to the electronic device through the interface, the electric power unit can exchange electric power with the electronic device, and the sound producing unit can issue a warning to users. For instance, the sound producing unit will warn users by beeping when the power level of the power bank is too low or while the power bank is being charged.

### BRIEF DESCRIPTION OF THE DRAWINGS

FIG. 1 is a schematic view of using a conventional power bank;

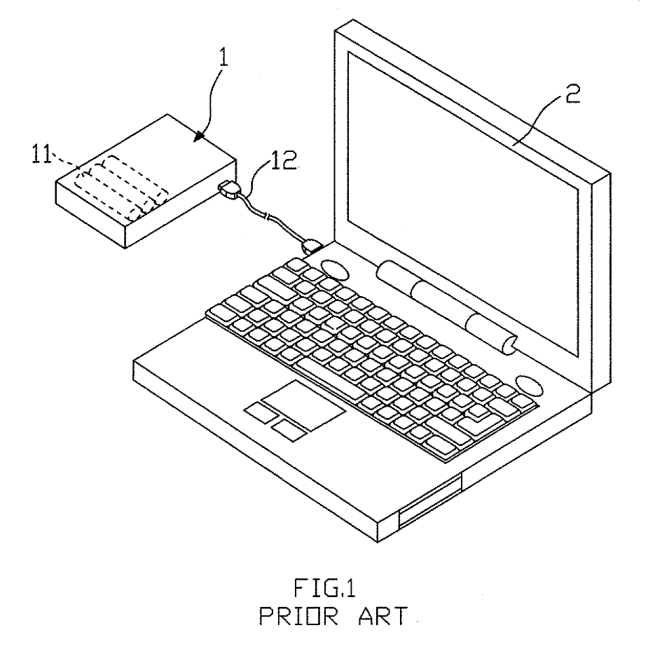

FIG. 2 is a schematic view of a power bank in accordance with a first preferred embodiment of the present invention;

FIG. 3 is a structural block diagram of a power bank in accordance with a first preferred embodiment of the present invention;

FIG. 4 is a schematic view of using a power bank in accordance with a first preferred embodiment of the present invention;

FIG. 5 is a schematic view of a sound producing unit and an electric power unit in accordance with the present invention;

FIG. 6 is a schematic view of a power bank in accordance with a second preferred embodiment of the present invention;

FIG. 7 is a schematic view of a power bank in accordance with a third preferred embodiment of the present invention;

FIG. 8 is a schematic view of a power bank in accordance with a fourth preferred embodiment of the present invention; and

FIG. 9 is a schematic view of a power bank in accordance with a fifth preferred embodiment of the present invention.

### DETAILED DESCRIPTION OF THE PREFERRED EMBODIMENTS

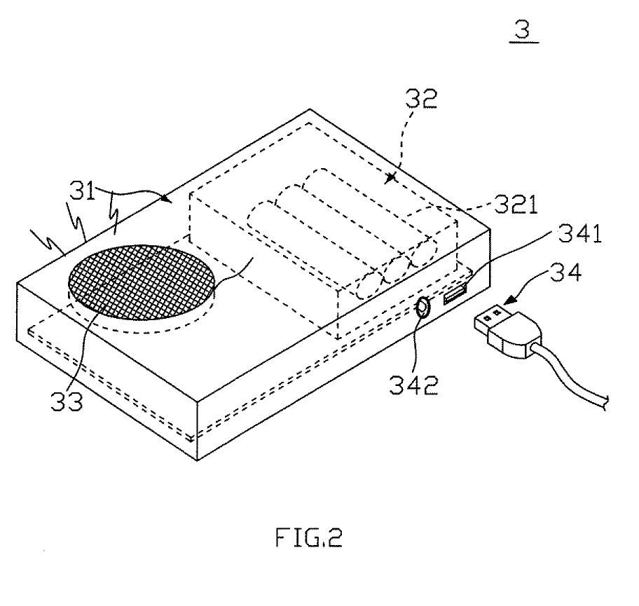

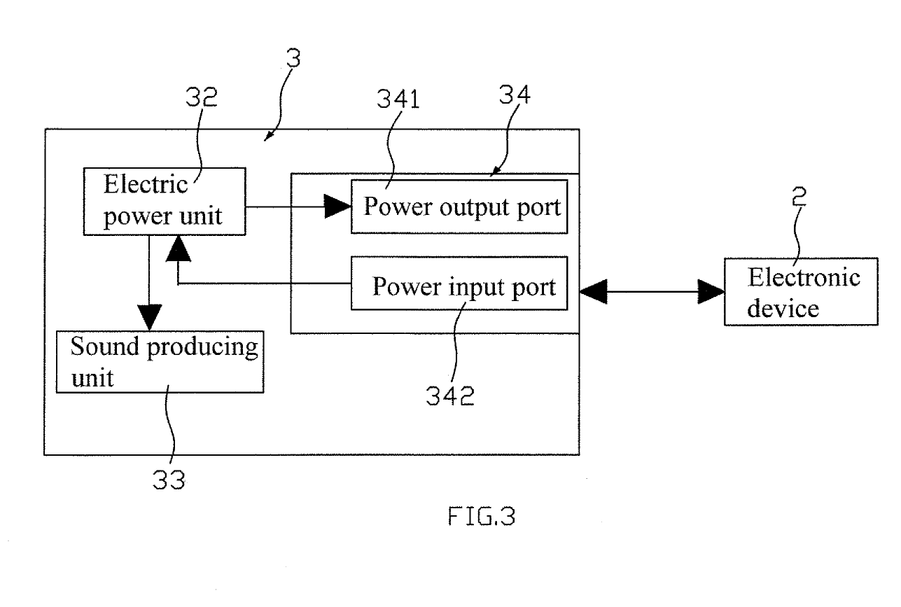

With reference to FIGS. 2 and 3 for a multifunctional power bank structure in accordance with a first preferred embodiment of the present invention, the power bank 3 comprises a box 31 for installing various different component modules, an electric power unit 32 and a sound producing unit 33 installed in the box 31, and an interface 34 disposed on the box 31 and connected to an external electronic device 2. In the figures, the interface 34 includes a power output port 341 and a power input port 342, and the sound producing unit 33 is connected to the electric power unit 32, and an end of the interface 34 is connected to the electric power unit 32, and another end of the interface 34 is connected to the external electronic device 2, wherein the electric power unit 32 includes a plurality of chargeable batteries 321.

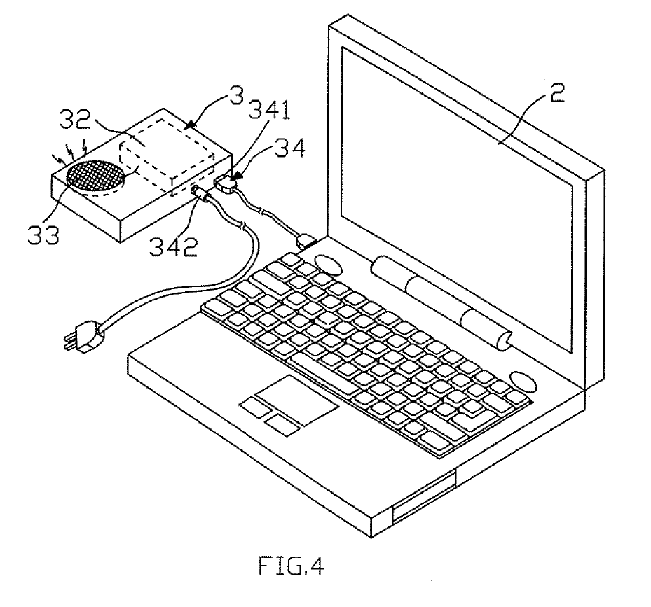

During use, the power output port 341 and the electronic device 2 are connected as shown in FIG. 4, and the electronic device 2 can be a notebook computer, and the electric power unit 32 can exchange electric power with the electronic device 2. For example, if the electronic device 2 runs out of power, then the electric power unit 32 will supply electric power to maintain the normal operation of the electronic device 2. Further, the power input port 342 can be connected to a power supply (such as a utility power) for charging the electric power unit 32. Of course, the interface can install a plurality of power output ports for supplying power to a plurality of electronic devices.

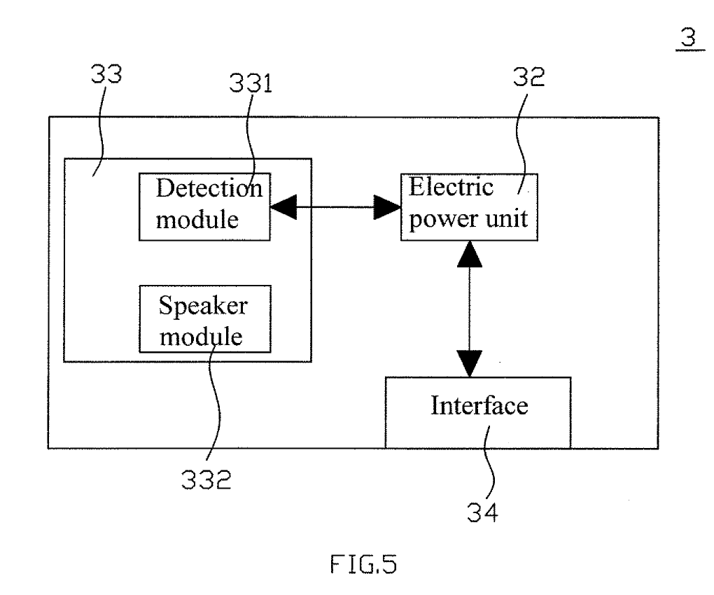

Further, the sound producing unit 33 can be connected to a detection module 331 and a speaker module 332 of the electric power unit 32 as shown in FIG. 5, and the detection module 331 is provided for detecting the power level of the electric power unit 32 and setting the maximum and minimum power levels. If the power level of the electric power unit 32 reaches or exceeds the maximum power level or reaches below the minimum power level, the detection module 331 will issue a signal to drive the speaker module 332 to produce a sound to remind users.

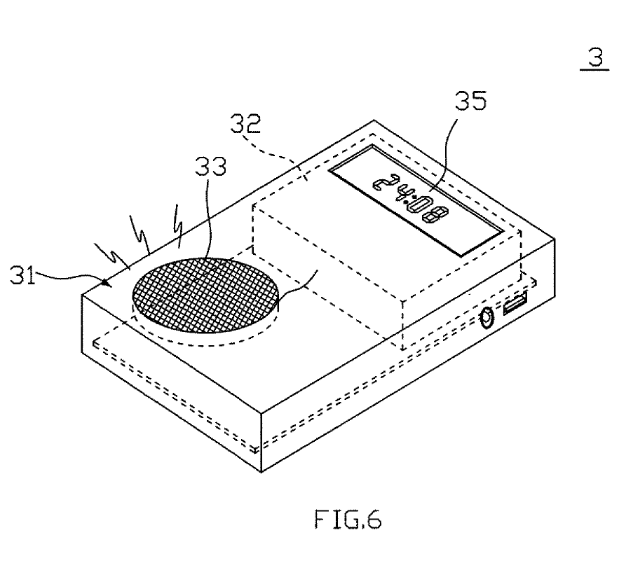

With reference to FIG. 6 for a second preferred embodiment of the present invention, the box 31 further includes a time display unit 35 connected to the electric power unit 32 and the sound producing unit 33 for giving time, such that the power bank 3 has the function of an alarm clock, and the power bank 3 can supply the required electric power for maintaining the using time of the alarm clock.

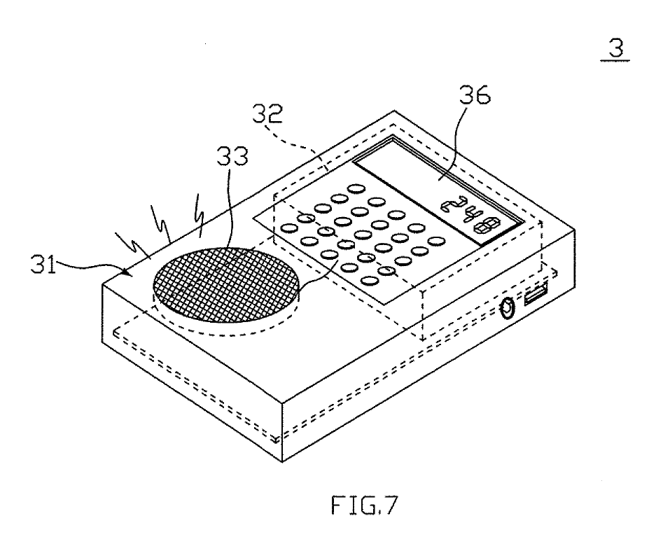

With reference to FIG. 7 for a third preferred embodiment of the present invention, the box 31 further includes a computing unit 36 connected to the electric power unit 32, such that the power bank has the function of a calculator, and the power bank 3 can supply the required electric power for maintaining the using time of the calculator.

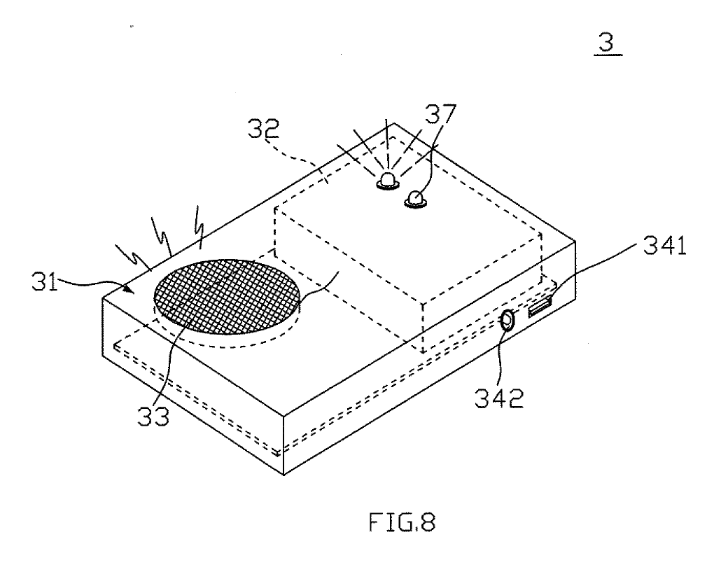

With reference to FIG. 8 for a fourth preferred embodiment of the present invention, the box 31 further includes a display unit 37 connected to the electric power unit 32, and the display unit 37 can issue a warning. For example, if the power level of the power bank is too low or the power bank is being charged, the display unit 37 will show the remaining power level by lit lamps of different colors to remind users about the power level.

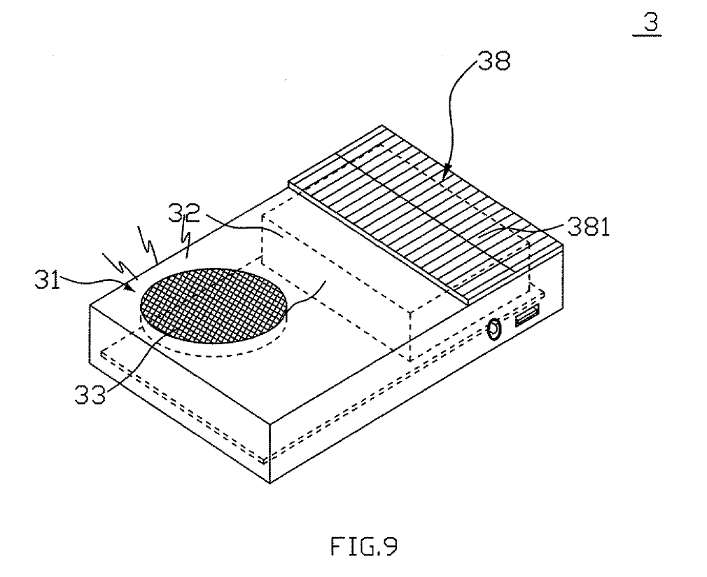

With reference to FIG. 9 for a fifth preferred embodiment of the present invention, the box 31 further includes a solar energy storage unit 38 connected to a solar panel 381 of the electric power unit 32, such that after the solar panel 381 absorbs and converts the energy of a light source into electric power, the electric power is transmitted from the solar panel 381 to the electric power unit 32.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

I claim:

1. A multifunctional power bank structure, comprising:
a box, for containing each component module;
an electric power unit, installed in the box;
a sound producing unit, installed in the box, and coupled to the electric power unit;
at least one interface, installed on the box, and each interface having an end coupled to electric power unit, and another end coupled to an external electronic device.

2. The multifunctional power bank structure of claim 1, wherein the sound producing unit includes a detection module and a speaker module, both coupled to the electric power unit.

3. The multifunctional power bank structure of claim 1, wherein the box further includes a time display unit coupled to the electric power unit and a sound producing unit for a function of giving time.

4. The multifunctional power bank structure of claim 3, wherein the box further includes a solar energy storage unit, and the solar energy storage unit includes a solar panel coupled to the electric power unit.

5. The multifunctional power bank structure of claim 1, wherein the box further includes a computing unit coupled to the electric power unit.

6. The multifunctional power bank structure of claim 5, wherein the box further includes a solar energy storage unit, and the solar energy storage unit includes a solar panel coupled to the electric power unit.

7. The multifunctional power bank structure of claim 1, wherein the box further includes a display unit coupled to the electric power unit.

8. The multifunctional power bank structure of claim 7, wherein the box further includes a solar energy storage unit, and the solar energy storage unit includes a solar panel coupled to the electric power unit.

9. The multifunctional power bank structure of claim 1, wherein the box further includes a solar energy storage unit, and the solar energy storage unit includes a solar panel coupled to the electric power unit.

10. The multifunctional power bank structure of claim 1, wherein the interface includes a power output port and a power input port.

11. The multifunctional power bank structure of claim 1, wherein the electric power unit includes a plurality of chargeable batteries.
